(19) United States
(12) Patent Application Publication
(10) Pub. No.: US 2011/0110121 A1
(43) Pub. Date: May 12, 2011

(54) POWER SUPPLY CIRCUIT

(75) Inventors: HE-KANG ZHOU, Shenzhen (CN); CHING-CHUNG LIN, Miao-Li County (TW)

(73) Assignees: INNOCOM TECHNOLOGY (SHENZHEN) CO., LTD., Shenzhen City (CN); CHIMEI INNOLUX CORPORATION, Miao-Li County (TW)

(21) Appl. No.: 12/890,691

(22) Filed: Sep. 26, 2010

(30) Foreign Application Priority Data
Nov. 9, 2009 (CN) 200910309445.7

(51) Int. Cl. H02M 3/335

(52) U.S. Cl. 363/21.1

(57) ABSTRACT

A power supply circuit includes a rectifying circuit, at least one filter member, a transformer, and a control circuit. The rectifying circuit is configured to receive a primary AC voltage signal and convert the primary AC voltage signal to a DC voltage signal. The at least one filter member is grounded via a current-limiting module, and is configured to filter the DC voltage signal. The transformer is configured to transform the filtered DC voltage signal to a main power voltage signal, and output the main power voltage signal. The control circuit is configured to enable the current-limiting element to function when the power supply circuit is powered on, and disable the current-limiting element when the power supply circuit is in a normal working state.

### BACKGROUND

1. Technical Field

The present disclosure relates to power supply technology, and more particularly, to a switching mode power supply circuit.

2. Description of Related Art

Power supply circuits supply voltage signals to enable operation of electronic devices.

Switching mode power supply circuits provide operating power to liquid crystal displays (LCD). FIG. 2 is a diagram of a commonly used switching mode power supply circuit. The power supply circuit 10 includes a first input 11, a second input 12, a full-wave rectifier 13, a filter capacitor 17, and a transformer 18.

The first input 11 and the second input 12 are electrically coupled to a live wire and a neutral wire of a commercial power outlet (not shown) respectively, and cooperatively receive a primary alternating-current (AC) voltage signal output by the commercial power outlet.

The full-wave rectifier 13 is electrically coupled to the first and second inputs 11 and 12, and in particular, to the first input 11 via a thermal resistor 16. The full-wave rectifier 13 is adapted to convert the primary AC voltage signal to a direct current (DC) voltage signal. An output of the full-wave rectifier 13 is further electrically coupled to the filter capacitor 17, adapted to filter and stabilize the DC voltage signal and provide the filtered DC voltage signal to the transformer 18. The transformer 18 is adapted to convert the filtered DC voltage signal to a power voltage signal with a desired value in a switching manner, and output the power voltage signal to a load circuit (not shown).

Resistance of the thermal resistor 16 decreases with an increase rise in temperature. When the power supply circuit 10 is powered on and starts to function, temperature of the thermal resistor 16 is low, and resistance of the thermal resistor 16 relatively high, such only limited current flows to the filter capacitor 17. In this configuration, the filter capacitor 17 is prevented from damaged by current surge. That is, the thermal resistor 16 protects the filter capacitor 17 from damaged at power up. Thereafter, the power supply circuit 10 enters a normal working state, and temperature of the thermal resistor 16 increases due to current therethrough, and resistance of the thermal resistor 16 is decreased.

During normal operations, however, the resistance of the thermal resistor 16 maintains a certain positive value, for example, 3Ω (ohms). Such positive resistance means that the thermal resistor 16 needs to consume some power energy, this may further increase power consumption of the power supply circuit 10.

What is needed, therefore, is a power supply circuit that can overcome the described limitations.

### BRIEF DESCRIPTION OF THE DRAWINGS

The components in the drawings are not necessarily drawn to scale, the emphasis instead placed upon clearly illustrating the principles of at least one embodiment. In the drawings, like reference numerals designate corresponding parts throughout the various views.

FIG. 1 is a circuit diagram of a power supply circuit according to an embodiment of the present disclosure.

FIG. 2 is a circuit diagram of a commonly used switching mode power supply circuit

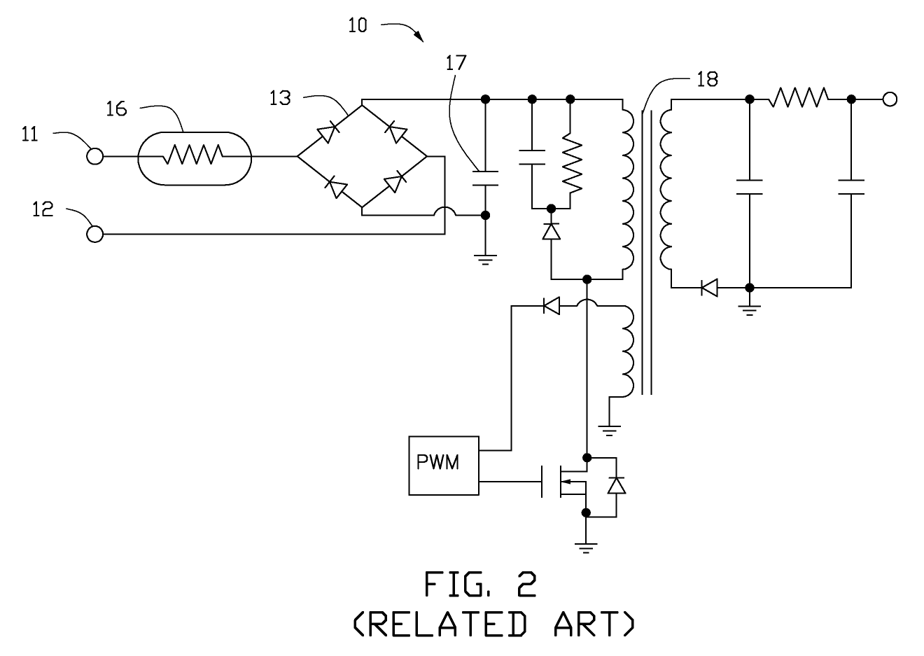

### DETAILED DESCRIPTION

Reference will now be made to the drawings to describe certain exemplary embodiments of the present disclosure in detail.

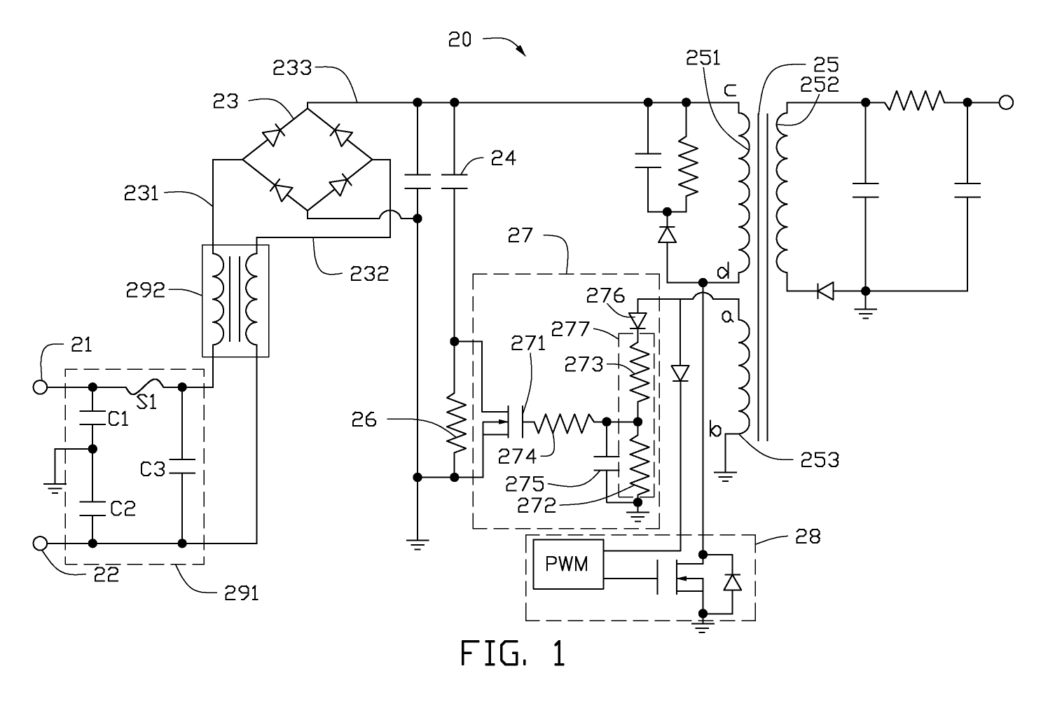

FIG. 1 is a circuit diagram of a power supply circuit 20 according to an embodiment of the present disclosure. The power supply circuit 20 may be a switching mode power supply circuit, which includes a first input 21, a second input 22, a protection circuit 291, an anti-interference circuit 292, a rectifying circuit 23, at least one filter member 24, a transformer 25, a current-limiting module 26, a control circuit 27, and a switching circuit 28.

The first input 21 and the second input 22 are electrically coupled to a live wire and a neutral wire of a commercial power outlet (not shown) respectively, and cooperatively receive a primary alternating-current (AC) voltage signal.

The protection circuit 291 and the anti-interference circuit 292 are electrically coupled between the inputs 21, 22 and the rectifying circuit 23. The protection circuit 291 prevents hazards occurring when the power supply circuit 20 is broken. In one embodiment, the protection circuit 29 may include a first safety capacitor C1, a second safety capacitor C2, a third safety capacitor C3, and a fuse wire S1. The first safety capacitor C1 is electrically coupled between the live wire and the ground, and the second safety capacitor C2 is electrically coupled between the neutral wire and the ground, in particular, both of the first safety capacitor C1 and the second safety capacitor C2 can be Y-type safety capacitors. The third safety capacitor C3 can be an X-type safety capacitor, and is electrically coupled between the live wire and the neutral wire. The fuse wire S1 is electrically coupled into the live wire, and between the first safety capacitor C1 and the third safety capacitor C3.

The anti-interference circuit 292 is adapted to inhibit electro-magnetic interference (EMI) in the power supply circuit 20. The anti-interference circuit 292 may be a common mode choke which includes a first coil and a second coil. The first and second coils are electrically coupled into the live wire and the neutral wire respectively.

The rectifying circuit 23 is adapted to convert the primary AC voltage signal into a direct current (DC) voltage signal. In one embodiment, the rectifying circuit 23 may be a full-wave rectifier, for example, a bridge type rectifier. An output of the rectifying circuit 23 is further electrically coupled to the filter member 24.

The at least one filter member 24 is adapted to filter and stabilize the DC voltage signal, and provide the filtered DC voltage signal to the transformer 25. In one embodiment, the at least one filter member 24 may include a filter capacitor, which is grounded via the current-limiting module 26.

The current-limiting module 26 is adapted to limit current through the filter capacitor 24 when the power supply circuit 20 is powered on. In one embodiment, the current-limiting module 26 can be a current-limiting resistor having a pre-determined resistance, for example, about 100Ω. In an alternative embodiment, the current-limiting module 26 may include a plurality of current-limiting resistors connected in series between the at least one filter member and the ground, or include other current-limiting elements connected in other manners as needed.

The transformer 25 is adapted to transform the filtered DC voltage signal, in a switching manner, to a main power voltage signal with a desired value, and output the main power voltage signal to a load circuit (not shown). In one embodiment, the transformer 25 may further generate an inner power voltage signal for the control circuit 27 and the switching circuit 28.

In particular, the transformer may include a first winding 251, a second winding 252, and a third winding 253. One end of the first winding 251 receives the filtered DC voltage signal, and the other end of the first winding 251 is electrically coupled to the switching circuit 28. Due to a switching operation performed by the switching circuit 28, a main power voltage signal is induced by the second winding 252, and an inner power voltage signal is induced by the third winding 253. The main power voltage signal is further provided to the load circuit after being rectified and filtered, and the inner power voltage signal is provided to the control circuit 27.

The control circuit 27 is adapted to enable the current-limiting module 26 when the power supply circuit 20 is powered on, and disable the current-limiting module 26 when the power supply circuit 20 is in a normal working state. In one embodiment, the control circuit 27 includes a switch member 271, a voltage-dividing module 277, a diode 276, and a capacitor 275.

A positive end of the diode 276 receives the inner power voltage signal, and a negative end of the diode 276 is grounded via the voltage-dividing module 277. The voltage-dividing module 277 is adapted to convert the inner power voltage signal to a bias voltage by performing a voltage division operation on the inner power voltage signal, and provides the bias voltage to the switch member 271. In this manner, the bias voltage may server as a control signal, and controls a working state of the switch member 271. In the illustrated embodiment, the voltage-dividing module 277 includes a first resistor 273 and a second resistor 272 connected in series. One end of the capacitor 275 is electrically coupled to a node between the first resistor 273 and the second resistor 272, and the other end of the capacitor 275 is grounded.

The switch member 271 includes a control terminal and two connecting terminals. The control terminal is configured to receive the control signal, and is electrically coupled to a node between the first resistor 273 and the second resistor 272. The two connecting terminals are respectively connected to two ends of the current-limiting resistor 26. The switch member 271 may control a connection between the two connecting terminals according to the control signal. The switch member 271 may be a transistor, for example, a metal oxide semiconductor (MOS) transistor, or a bipolar junction transistor (BJT). In the illustrated embodiment, the switch member 271 is an N-channel MOS transistor, which includes a gate electrically coupled to the node between the first resistor 273 and the second resistor 272 via a third resistor 274, a drain electrode electrically coupled to an end of the current-limiting module 26, and a source electrode electrically coupled to the other end of the current-limiting module 26.

In operation, when the power supply circuit 20 is powered on, the inner power voltage signal is induced by the third winding 253, and provided to the control circuit 27. Due to charging of the capacitor 275, a value of the bias voltage generated by the voltage-dividing module 277 is restrained and increases slowly, and before the bias voltage reaches a pre-determined threshold value sufficient to switch the switch member 271 on, the switch member 271 remains off. Thus, the current-limiting module 26 is enabled to limit current through the filter capacitor 242, such that the filter capacitor 24 is prevented from damage by intolerance current. When the charging operation of the capacitor 275 is substantially finished, the bias voltage reaches the pre-determined threshold value, thus, the switch member 271 is switched on and the current-limiting module 26 is shorted and disabled. Accordingly, the power supply circuit 20 enters a normal working state, and stably provides the main power voltage signal to the load circuit. Moreover, when the power supply circuit 20 is shut down, the capacitor 275 can be discharged through the second resistor 272, as such, it can be ensured that the current-limiting module 26 is ready to function the next time the power supply circuit 20 is powered on.

In the configuration disclosed, when the power supply circuit 20 is in normal working state, the current-limiting module 26 is shorted and thereby substantially consumes no energy. Thus, overall power consumption of the power supply circuit 20 is reduced.

It is to be further understood that even though numerous characteristics and advantages of a preferred embodiment have been set out in the foregoing description, together with details of the structures and functions of the embodiments, the disclosure is illustrative only; and that changes may be made in detail, especially in matters of shape, size and arrangement of parts within the principles of disclosure to the full extent indicated by the broad general meaning of the terms in which the appended claims are expressed.

What is claimed is:

1. A power supply circuit, comprising:
a rectifying circuit configured to receive a primary alternating-current (AC) voltage signal, and convert the primary AC voltage signal into a direct current (DC) voltage signal;
at least one filter member configured to filter the DC voltage signal, the at least one filter member being grounded via a current-limiting module;
a transformer configured to transform the filtered DC voltage signal into a main power voltage signal, and output the main power voltage signal; and
a control circuit configured to enable the current-limiting module to function when the power supply circuit is powered on, and disable the current-limiting element when the power supply circuit is in a normal working state.

2. The power supply circuit of claim 1, wherein the current-limiting module is configured to limit current through the at least one filter member when the power supply circuit is powered on.

3. The power supply circuit of claim 2, wherein the current-limiting module comprises at least one current-limiting resistor electrically connected between the at least one filter member and the ground.

4. The power supply circuit of claim 3, wherein the at least one filter member comprises a filter capacitor, grounded via the at least one current-limiting resistor.

5. The power supply circuit of claim 1, wherein the transformer is further configured to transform the filtered DC voltage signal to an inner power voltage signal and provide the inner power voltage signal to the control circuit.

6. The power supply circuit of claim 5, wherein the control circuit comprises a switch member, a first resistor, a second resistor, and a capacitor, one end of the first resistor receives the inner power voltage signal via a diode, the other end of the first resistor is grounded via the second resistor and the capacitor connected in parallel, the switch member comprises a control terminal electrically coupled to a node between the first resistor and the second resistor, and two connecting terminals are electrically coupled to two ends of the current-limiting module.

7. The power supply circuit of claim 6, wherein the first resistor and the second resistor cooperatively convert the inner power voltage signal to a bias voltage, the capacitor is configured to restrain a value of the bias voltage via a charging operation, and the switch member receives the bias voltage via the control terminal, and controls a connection between the two connecting terminal according to the value of the bias voltage.

8. The power supply circuit of claim 7, wherein the switch member is a metal oxide semiconductor (MOS) transistor, a gate electrode of the MOS transistor is configured as the control terminal and receives the bias voltage via a third resistor, and a source electrode and a drain electrode are configured as the two connecting terminals.

9. The power supply circuit of claim 5, wherein the transformer comprises a first winding, a second winding, and a third winding, one end of the first winding is configured to receive the filtered DC voltage signal, and the other end of the first winding is electrically coupled to a switching circuit, the switching circuit is configured to perform a switching operation, enabling the second winding to induce the main power voltage signal, and the third winding to induce the inner power voltage signal.

10. The power supply circuit of claim 1, further comprising a protection circuit and an anti-interference circuit, wherein the protection circuit comprises a first Y-type safety capacitor electrically coupled between a live wire and the ground, a second Y-type safety capacitor electrically coupled between a neutral wire and the ground, an X-type safety capacitor electrically coupled between the live wire and the neutral wire, and a fuse wire electrically coupled into the live wire and between the first safety capacitor and the third safety capacitor; and wherein the anti-interference circuit is adapted to restrain electro-magnetic interference (EMI) in the power supply circuit, and is electrically coupled between the a protection circuit and the rectifying circuit.

11. A power supply circuit, comprising:
a rectifying circuit configured to receive a primary alternating-current (AC) voltage signal, and converting the primary AC voltage signal into a direct current (DC) voltage signal;
at least one filter member configured to filter the DC voltage signal, the at least one filter member being grounded via a current-limiting module; and
a transformer configured to transform the filtered DC voltage signal to a main power voltage signal, and output the main power voltage signal;
wherein the current-limiting module is configured to limit current through the at least one filter member when the power supply circuit is powered on.

12. The power supply circuit of claim 11, further comprising a control circuit configured to enable the current-limiting element to function when the power supply circuit is powered on, and disable the current-limiting element when the power supply circuit is in a normal working state.

13. The power supply circuit of claim 11, wherein the current-limiting module comprises at least one current-limiting resistor electrically connected between the at least one filter member and the ground.

14. The power supply circuit of claim 13, wherein the at least one filter member comprises a filter capacitor, grounded via the at least one current-limiting resistor.

15. The power supply circuit of claim 12, wherein the transformer is further configured to transform the filtered DC voltage signal to an inner power voltage signal, and provide the inner power voltage signal to the control circuit.

16. The power supply circuit of claim 15, wherein the control circuit comprises a switch member, a first resistor, a second resistor, and a capacitor, one end of the first resistor receives the inner power voltage signal via a diode, the other end of the first resistor is grounded via the second resistor and the capacitor connected in parallel, the switch member comprises a control terminal electrically coupled to a node between the first resistor and the second resistor, and two connecting terminals are electrically coupled to two ends of the current-limiting module.

17. The power supply circuit of claim 16, wherein the first resistor and the second resistor cooperatively convert the inner power voltage signal to a bias voltage, the capacitor is configured to restrain a value of the bias voltage via a charging operation, and the switch member receives the bias voltage via the control terminal, and control a connection between the two connecting terminal according to the value of the bias voltage.

18. The power supply circuit of claim 17, wherein the switch member is a metal oxide semiconductor (MOS) transistor, a gate electrode of the MOS transistor is configured as the control terminal, and receives the bias voltage via a third resistor, and a source electrode and a drain electrode are configured as the two connecting terminals.

19. The power supply circuit of claim 15, wherein the transformer comprises a first winding, a second winding, and a third winding, one end of the first winding is configured to receive the filtered DC voltage signal, and the other end of the first winding is electrically coupled to a switching circuit, the switching circuit is configured to perform a switching operation, enabling the second winding to induce the main power voltage signal, and the third winding to induce the inner power voltage signal.

20. A power supply circuit, comprising:
a rectifying circuit configured to receive a primary alternating-current (AC) voltage signal, and convert the primary AC voltage signal into a direct current (DC) voltage signal;
a filter member electrically coupled to an output of the rectifying circuit, and configured to filter the DC voltage signal, wherein the filter member is grounded via a current-limiting module;
a transformer electrically coupled to the filter member, and configured to transform the filtered DC voltage signal to a power voltage signal in a switching manner;
wherein the current-limiting module is electrically coupled between the filter member and the ground when the power supply circuit is powered on, and is shorted when the power supply circuit is in a normal working state.
